(19) United States
(12) Patent Application Publication
(10) Pub. No.: US 2022/0074874 A1
(43) Pub. Date: Mar. 10, 2022

(54) COMPUTER-IMPLEMENTED METHOD FOR ANALYSING MEASUREMENT DATA FROM A MEASUREMENT OF AN OBJECT

(71) Applicants: Matthias FLESSNER, Heidelberg (DE); Christof REINHART, Heidelberg (DE); Thomas GÜNTHER, Heidelberg (DE); Volume Graphics GmbH, Heidelberg (DE)

(72) Inventors: Matthias FLESSNER, Heidelberg (DE); Christof REINHART, Heidelberg (DE); Thomas GÜNTHER, Heidelberg (DE)

(21) Appl. No.: 17/417,005

(22) PCT Filed: Oct. 14, 2019
(86) PCT No.: PCT/EP2019/077768

§ 371 Date: Jun. 21, 2021

(30) Foreign Application Priority Data
Dec. 20, 2018 (DE) 10 2018 133 092.8

(51) Int. Cl. G01N 23/046; G01B 21/08; G01N 23/06; G01N 23/18

(52) U.S. Cl. CPC G01N 23/046; G01B 21/08; G01N 23/06; G01N 2223/646; G01N 2223/04; G01N 2223/419; G01N 23/18

(57) ABSTRACT

A computer-implemented method for analysing measurement data from a measurement of an object to assess whether the object corresponds to a target condition, by the following steps: determining measurement data of a plurality of objects; determining analysis data records from the measurement data, an analysis data record being assigned to one of the objects and having at least one analysis result about the conformity of the assigned object to the target condition; checking, by a user, some of the analysis results; adapting an analysis result if the checking results in a different analysis result about the conformity; and transmitting the adapted analysis data records to a learning algorithm that modifies itself on the basis of the adapted analysis data records, in order to determine analysis data records from additional measurement data of objects; and the steps are carried out one after another or with an at least partial temporal overlap.

The invention relates to a computer-implemented method for analyzing measurement data from a measurement of an object, wherein the analysis assesses whether the object corresponds to a target state.

For quality control of objects, nondestructive measurements can be carried out in order to capture the structure of the objects that is not visible from outside. The objects can be components, for example, which are combined to form larger objects. If the nondestructive measurement reveals that there are defects in the component, such as, for example, pores, voids, inclusions, regions of increased porosity or structural loosening, etc., it is necessary to evaluate whether the functionality of the object is impaired by these defects. This involves taking a conformity decision which evaluates whether the object is okay or not okay and whether it thus has conformity to the requirements defined in the technical drawing, in the product specification or elsewhere. This quality control has particular relevance for objects manufactured by means of additive manufacturing or molding/casting, e.g. injection molding, die casting or shape casting. However, the fundamental need for this quality control is independent of the method used to manufacture the object.

Automatable algorithms exist which, in accordance with a catalog of criteria predefined by a user, evaluate whether or not an object is okay. The predefined catalog of criteria generally deduces the functionality of the object from geometric properties of the object. This is only possible with a degree of fuzziness, however, since even further items of information about the defect, which are not taken into account by the algorithms, are generally relevant for evaluating the functionality of the object.

For these reasons, the evaluations of the automatic algorithms are submitted to an expert for manual checking if said algorithms cannot clearly evaluate whether relevant defects are present and/or if each defect found ought to be checked by an expert for the sake of safety. If the checking by the expert reveals that the decision of the algorithm is not correct, the expert corrects it. Cases in which the automatic algorithm did not arrive at an unambiguous result can likewise be submitted to the expert. However, both procedures are time-consuming and require relatively high resources in terms of personnel used.

Against this background, the present invention is based on the objective technical problem of providing an improved method for analyzing measurement data from a measurement of an object.

Main features of the invention are specified in claim 1 and claim 15. Claims 2 to 14 relate to configurations.

In a first aspect, the invention relates to a computer-implemented method for analyzing measurement data from a measurement of an object, wherein the analysis assesses whether the object corresponds to a target state, wherein the method comprises the following steps: determining measurement data of a plurality of objects; determining analysis data sets from the measurement data for the objects, wherein an analysis data set is assigned to one of the objects and has at least one analysis result about the conformity of the assigned object to the target state; checking, by a user, the analysis results of at least some of the analysis data sets; adapting an analysis result of a checked analysis data set if the checking by the user yields a deviating analysis result about the conformity of the assigned object to the target state; and communicating at least the adapted analysis data sets to the adaptive algorithm, wherein the adaptive algorithm modifies itself on the basis of the adapted analysis data sets in order to determine analysis data sets from further measurement data of objects by means of the modified adaptive algorithm; wherein the steps are carried out successively or with at least partial temporal overlap.

The computer-implemented method for analyzing measurement data from a measurement of an object determines measurement data of a plurality of objects in an automated manner. In this case, measurement data can be determined on the basis of measurement tasks of identical type, that is to say that the objects are measured or analyzed for example at similar locations, in a similar manner or in order to find similar deviations. Determining the measurement data can be effected by means of imaging methods such as computed tomography, for example, although this is not intended to exclude other measurement methods. In this case, determining the measurement data can be effected “inline” or “atline” and thus in a manner accompanying manufacture. Furthermore, determining the measurement data can comprise using measurement data, for example from series of measurements already carried out. The measurement data of the series of measurements already carried out can be loaded e.g. from a data carrier or some other storage medium or location.

Analysis data sets are determined from the measurement data for the objects in an automated manner. The analysis data sets can be determined for example by the adaptive algorithm that is intended to be trained. In another example, another, non-adaptive, i.e. conventional, algorithm can determine the analysis data sets. In this case, an analysis data set is assigned to an object. The analysis data sets further comprise at least one analysis result about the conformity of the actual state of the assigned measured object to the target state of the object. In this case, an analysis data set can comprise a plurality of analysis results from different analyses concerning an object. In this case, the algorithm used issues for example an assessment about whether a component, with regard to its geometry and material properties, is within the tolerances predefined by the designer and can thus fulfill its intended function. Moreover, the analysis results can include for example information about the location at which a critical defect was identified and/or about what regions were analyzed in what way. Furthermore, the analysis results can include an extract from the (raw) data of the measurement data or a visualization of the defect which makes possible or simplifies checking for a user.

At least some of the analysis data sets are checked by a user. In this case, the user checks the individual analysis results in the analysis data sets. It is possible to provide for checking by the user only those analysis data sets whose analysis results reveal a non-conformity of the object to the target state. Alternatively, it is possible to provide for checking only analysis data sets in which no clear evaluation about the conformity of the object can be determined from the analysis results. This can mean, for example, that the algorithm used cannot clearly evaluate from the analysis results whether the object is functional. In a further alternative, all the analysis data sets can be checked by the user. Non-conformity of the object to the target state is understood to mean deviations from the target state, such as e.g. defects.

If individual analysis results are evaluated by the user differently than what is stored in the checked analysis data set, the corresponding, differently evaluated analysis result is modified in the corresponding checked analysis data set.

At least the adapted analysis data sets from the checking by the user are communicated to the adaptive algorithm. The adaptive algorithm uses these adapted communicated analysis data sets to train itself. In this case, the adaptive algorithm modifies itself on the basis of the adapted communicated analysis data sets. Thus, by means of the checked analysis data sets, the adaptive algorithm learns to determine the functionality of objects, i.e. the conformity of the objects to the target state, on the basis of measurement data and to provide corresponding analysis results. Thus, from further measurement data, the adaptive algorithm can independently create analysis data sets having a lower proportion of checking by the user than before the learning process.

The preceding steps can be carried out successively in accordance with one exemplary embodiment, wherein firstly measurement data are determined for all the objects before an analysis takes place and the checking is carried out only after the analysis has concluded. In an alternative example, provided that the logical prerequisites are present, at least partial temporal overlap of the steps can be provided, such that determining the analysis data sets for the measurements already carried out is already begun for example during the process of determining the measurement data. Furthermore, if the corresponding prerequisites are present, for example, the further steps can already be carried out while the steps mentioned above are being carried out, i.e. the checking can begin if corresponding analysis data sets to be checked are present during the process of determining the analysis data sets, and modifying the adaptive algorithm can be carried out as soon as adapted analysis data sets start to be communicated. Furthermore, an iterative repetition of individual steps or sequences of steps is also conceivable.

The invention thus provides a computer-implemented method for analyzing measurement data which generates real training data for an adaptive algorithm for carrying out the analysis task. By training the adaptive algorithm with the real training data from ongoing measurements, it is possible for the trained adaptive algorithm to save time in the long term by comparison with manual monitoring of conventional analysis algorithms since fewer unclear cases are submitted to the user. Furthermore, the reduced effort for the user reduces the susceptibility to errors.

Determining analysis data sets from the measurement data for the objects can be performed by means of an assessment algorithm, which is different than the adaptive algorithm, and the method can additionally comprise the following step: replacing the assessment algorithm by the adaptive algorithm after a predefined minimum number of adapted analysis data sets have been communicated to the adaptive algorithm and/or after a predefined minimum number of analysis data sets have been determined.

This has the effect that firstly an assessment algorithm determines the analysis data sets. By way of the analysis data sets of the assessment algorithm that are checked by a user, the adaptive algorithm obtains training data in order to modify itself. Furthermore, the adaptive algorithm is used for determining the analysis data sets only if it has obtained a predefined minimum number of adapted analysis data sets as a basis for the modifications to itself. In this case, the predefined minimum number can be chosen by way of an estimation such that after the training with the predefined minimum number of analysis data sets, the adaptive algorithm produces fewer analysis results requiring checking or correction by the user than the assessment algorithm. Alternatively, the adaptive algorithm can replace the assessment algorithm as soon as a predefined minimum number of analysis data sets have been determined. In this case, the predefined minimum number of analysis data sets can be based on an estimation over an accompanying number of checks by the user. Both increase the efficiency of the training of the adaptive algorithm and reduce a high number of checks by the user during the training process of the adaptive algorithm.

In accordance with a further example, determining analysis data sets from the measurement data for the objects can be performed by means of an assessment algorithm, which is different than the adaptive algorithm, and after the checking of the analysis data sets by the user the method can comprise the following step: determining training analysis data sets from the measurement data for the objects by means of the adaptive algorithm; and comparing the adapted analysis data sets with the corresponding training analysis data sets before communicating the adapted analysis data sets to the adaptive algorithm; wherein the assessment algorithm is replaced by the adaptive algorithm if at least some of the adapted analysis data sets match the corresponding training analysis data sets.

The adaptive algorithm thus determines training analysis data sets from the measurement data before or while the adaptive algorithm is trained by the checked and adapted analysis data sets. In this case, the training analysis data sets serve only for comparison with the adapted analysis data sets and are not used for the assessment of the conformity of the objects to the target state. The adaptive algorithm then replaces the conventional assessment algorithm when determining the analysis data sets only if the comparison between the training analysis data sets and the analysis data sets of the assessment algorithm reveals a sufficiently great match between the training analysis data sets of the adaptive algorithm and the analysis data sets of the assessment algorithm. In this case, the match between the conventional assessment algorithm and the training data sets can also be taken into account or used as a reference in order to be able to determine a suitable point in time at which the adaptive algorithm replaces the conventional assessment algorithm.

According to a further exemplary embodiment, provision can be made for the method additionally to comprise the following step: providing the adapted analysis data sets for the assigned objects by way of an output unit.

The analysis data sets adapted by the user are thus output directly as the final result of the analysis by way of an output unit. The adapted analysis data sets are thus used firstly for the improvement of the adaptive algorithm and secondly as the final result of the quality assurance.

It can likewise be advantageous for before the checking of the analysis data sets by a user the method to comprise the following step: marking an analysis data set if at least one analysis result about the conformity of the assigned object to the target state is not unambiguous; and using only the marked analysis data sets during the checking of the analysis data sets by the user.

Thus, only uncertain analysis results are submitted to the user for checking, i.e. analysis results which the method classifies as not unambiguously okay or as not unambiguously not okay. Thus, analysis results classified as certain are not checked by the user. This reduces the effort and increases the speed of the method. The classification as an uncertain analysis result can be effected e.g. a tolerance range divided into three. One tolerance range in each case comprises analysis results classified as okay and not okay, respectively. Arranged between these two tolerance ranges is a third tolerance range, in which the method cannot carry out a clear assessment. These analysis data sets, having an analysis result that was categorized in the third tolerance range, are checked manually by the user. Alternatively, provision can be made for the method to specify an output variable used to check the conformity of the assigned object. In this case, the output variable can specify the extent to which the structure examined is similar to a pattern sought, which may be e.g. a problematic defect. In this regard, depending on the definition, this output variable can have a value of 1, for example, if there is certainly a problematic defect. In the case of a value of 0, there would certainly not be a problematic defect. In the case of a value of 0.5, the decision would thus be very uncertain. Accordingly, a measure of the uncertainty can be implicitly derived in this way. Furthermore, for the classification, provision can alternatively be made for an independent, dedicated measure of uncertainty to be output. In this case, the measure of uncertainty can be output by a conventional algorithm or by a further adaptive algorithm, for example. One simple example would be the indication of a signal-to-noise ratio. The noisier the data, the more uncertain the analysis results. The further adaptive algorithm here can be an adaptive algorithm that is separate from the calculation of the actual analysis result, or else a combined adaptive algorithm that determines both the analysis result and an associated uncertainty.

The measurement data can provide at least one partial representation of a volume arranged within an object.

Thus, the interior of an object can be analyzed. Deviations from the target state in the interior of the object which influence the functionality of the object can thus be recognized. The analysis can be carried out on the basis of volumetric data or volume data. In a further example, other data that image the interior of the object, such as two-dimensional radiographs, for example, can be analyzed.

Determining measurement data of a plurality of objects can furthermore comprise the following step: providing volume data by means of a measurement by computed tomography.

The measurement by computed tomography makes it possible to provide meaningful high-resolution volume data in an efficient manner. The volume data provided capture the structure of the object in its entirety, such that deviations in the volume and at the surface of the object can be captured.

It can furthermore be advantageous that determining measurement data of a plurality of objects comprises the following step: providing volume data as measurement data by means of process data of a measurement during additive manufacturing of an object.

Thus, the construction of the internal structure of the object can be determined directly from the process data of a measurement during the production of the object. In this case, the process data can be spatially resolved information about physical variables, for example the proportion of a laser power that is reflected by the object, while a volume element of the object is being manufactured. Directly after or even during the completion of the object, these data can be fed to the analysis for deviations from the target state, i.e. the analysis data sets can be determined directly. Since defects are manifested comparatively complexly in these data, only a few algorithms suitable for such automatic analyses have existed hitherto, and it has regularly been necessary for a large number of analysis data sets to be checked by a user. As a result of the training and use of the adaptive algorithm, the number of analysis data sets to be checked by a user can be reduced.

Determining analysis data sets from the measurement data for the objects can comprise the following step: assessing deviations in the interior of the object.

If a deviation in the interior of the object can be deduced from the measurement data, the deviation can be assessed with regard to the functionality of the object in the context of determining an analysis result. Deviations or defects which do not influence the functionality of the object can be evaluated as irrelevant, for example, and the analysis result can turn out to be positive, i.e. can indicate that the with regard to this analysis the object is okay. Otherwise, the defect can be evaluated as relevant and the analysis result can indicate that the object is not okay.

The defects or deviations from the target state of the object can be air inclusions, for example, which can have a wide variety of shapes, sizes, positions and other properties and can adversely influence the functionality of the object.

Furthermore, determining analysis data sets from the measurement data for the objects, before assessing deviations in the interior of the object, can comprise the following step: ascertaining segmentation data on the basis of the measurement data, wherein the segmentation data describe an internal composition of the object; wherein assessing deviations in the interior of the object is carried out on the basis of the segmentation data by means of the adaptive algorithm.

The geometry of the individual defects or deviations can thus be measured. Therefore, not just checking for the presence of a defect is carried out, but in addition the shape thereof is also determined. This can be carried out both in a voxel-based manner and with sub-voxel accuracy. The adaptive algorithm thus obtains training data with additional parameters concerning the deviations, on the basis of which an analysis result and a corresponding modification of the adaptive algorithm can be carried out. In this case, the segmentation data, which can be determined by a separate segmentation algorithm, for example, can describe the composition of the object by way of the provision of spatially resolved information as to whether material, air or defects is/are situated in a region or volume element. In this case, the segmentation algorithm can likewise be an adaptive algorithm that was trained with the aid of simulations, for example.

Furthermore, determining analysis data sets from the measurement data for the objects, before assessing deviations in the interior of the object, can comprise the following step: determining a local wall thickness at a position of a deviation; wherein assessing deviations in the interior of the object is carried out on the basis of the local wall thickness.

Deviations or defects in the interior of an object generally weaken the internal structure of the object. For a defect of the same size, said defect can have a greater effects on the functionality of the object if said defect is situated in a region of small wall thickness compared with if the defect is situated in a region of larger wall thickness. On this basis, the influence of a defect on the functionality of an object can take place on the basis of the wall thickness, inter alia.

Advantageously, communicating at least the adapted analysis data sets to the adaptive algorithm, wherein the adaptive algorithm modifies itself on the basis of the adapted analysis data sets, comprises the following step: communicating simulated analysis data sets based on simulated measurement data to the adaptive algorithm, wherein the adaptive algorithm modifies itself on the basis of the simulated analysis data sets.

By means of simulation, the entire measurement process, for example during computed tomography consisting of radiographic examination of the object, reconstruction and measurement data evaluation, can be simulated realistically. By means of the simulation of analysis data sets, the adaptive algorithm can thus be provided with a large number of analysis data sets, on the basis of which the adaptive algorithm can adapt itself. What is advantageous here is that the input parameters of the simulation and hence the geometry of the object are known, from which ground truth for a conformity decision can be derived in an automated manner and hence without any additional user input. In this case, the simulated analysis data sets can be used in addition to the analysis data sets generated by real measurements. Thus, it is not necessary first to wait for a large number of measurements during ongoing operation for the production of objects in order to train the adaptive algorithm. Just with a small number of deviations from the target state in the production process, accumulating suitable analysis data sets with which the adaptive algorithm can modify itself can take some time. Thus, by means of the simulated analysis data sets, the adaptive algorithm can more rapidly reach a state in which it recognizes deviations from the target state with higher certainty than a conventional non-adaptive algorithm.

In one exemplary embodiment, before determining analysis data sets from the measurement data for the objects the method can comprise the following steps: determining provisional analysis data sets from the measurement data for the objects by means of a defect recognition algorithm, wherein a provisional analysis data set is assigned to one of the objects and has at least one analysis result about the conformity of the assigned object to the target state; determining, by means of the defect recognition algorithm, whether the analysis result has a deviation of the conformity of the assigned object to the target state within a predefined range; communicating the measurement data of the objects whose provisional analysis data sets have an analysis result having a deviation of the conformity of the assigned object to the target state within the predefined range to the adaptive algorithm for determining analysis data sets from the measurement data for the objects.

In this example, determining analysis data sets from the measurement data for the objects, wherein an analysis data set is assigned to one of the objects and has at least one analysis result about the conformity of the assigned object to the target state, is carried out by means of the adaptive algorithm. By means of the defect recognition algorithm, which in this example does not correspond to the adaptive algorithm, but rather is a conventional algorithm, measurement data which unambiguously indicate deviations or unambiguously indicate no deviations from the target state can be filtered before the checking of the measurement data by the adaptive algorithm, such that the adaptive algorithm only analyzes measurement data concerning objects which do not allow any unambiguous analysis results by means of the defect recognition algorithm. Since the adaptive algorithm generally requires more computing power during execution than a conventional non-adaptive algorithm, i.e. is slower than the defect recognition algorithm, the entire method can be accelerated if an analysis by the adaptive algorithm is dispensed with in the case of unambiguous analysis results.

In an alternative or additional example, analyses that have already been carried out and have led to a positive result, after the analysis result has modified itself on the basis of the adapted analysis data sets, can be carried out again and in case of doubt can thus be categorized subsequently as not okay or as ambiguous. In this way, objects that were incorrectly categorized as okay can subsequently still be identified as not okay or be submitted to the user for a decision. The first analyses already carried out are thus regarded as provisional as long as the adaptive algorithm has not yet modified itself to an extent such that the decisions thereof have an acceptably low error rate. The acceptable error rates or error proportions can be predefined by a user. As long as the analysis is regarded as provisional, the corresponding objects are not yet used further, e.g. delivered or processed further. The second analysis newly carried out by the adaptive algorithm is assigned to the corresponding analysis data set or to the corresponding measurement data. Analogously, in this way even objects that were incorrectly categorized as not okay can also subsequently be identified as okay or regarded as ambiguous and submitted to the user for a decision. Unnecessary rejects can be minimized in this way.

Furthermore, provision can alternatively or additionally be made for all analyses to be regarded as provisional. In this case, the measurement data are stored until the adaptive algorithm achieves an acceptably low error proportion. Accordingly, all measurement data are analyzed anew with regard to their conformity and, depending on the result, only afterward are the corresponding objects classified and used further, if appropriate.

In a further example, the analysis data sets are generated by examining defects in the measurement data with regard to geometric properties such as size, shape, orientation, position in the component, but also proximity to other defects, and deriving therefrom a statement concerning the conformity of the object.

The method can likewise be used in order to analyze more complex geometries such as foam structures with regard to conformity. Furthermore, in this way it is also possible to examine image data of objects with regard to the presence of structures or geometries. Examples thereof may be whether a required soldered joint is absent or whether fitting, e.g. of a printed circuit board with components or of a plug with corresponding plug connections, has been carried out correctly or in a manner corresponding to the desired target state.

Furthermore, in a further example, samples of the analysis data sets determined by the adaptive algorithm can be submitted to the user for evaluation. The sample can be selected randomly or deliberately have analysis data sets which comprises comparatively clear assessments. The analysis data sets checked by the user can be submitted to the adaptive algorithm in order that the adaptive algorithm modifies itself on the basis of these analysis data sets. The risk of the adaptive algorithm being trained erroneously with regard to specific features is minimized in this way.

In a further example, analysis data sets from different measurement systems can be combined, wherein the adaptive algorithm uses the combined analysis data sets in order to modify itself on the basis thereof. In this case, the analysis data sets can be combined by different users, for example, wherein the analysis data sets are communicated to a central location e.g. by means of a network application. This involves examining ideally identical or similar measurement tasks with identical or similar recording parameters.

Furthermore, provision can be made, for example, for the adaptive algorithm to obtain separate analysis data sets for different regions of the object, in which different tolerances can be defined, for example, in order that said adaptive algorithm modifies itself on the basis of said analysis data sets.

Alternatively or additionally, for the different regions different adaptive algorithms can be used for the analysis, that is to say that the different adaptive algorithms are specialized for a specific region.

In a further aspect, the invention relates to a computer program product comprising instructions which are executable on a computer and, when executed on a computer, cause the computer to carry out the method according to the description above.

The advantages and developments of the computer program product are evident here from the description above.

Further features, details and advantages of the invention are evident from the wording of the claims and also from the following description of exemplary embodiments with reference to the drawings, in which:

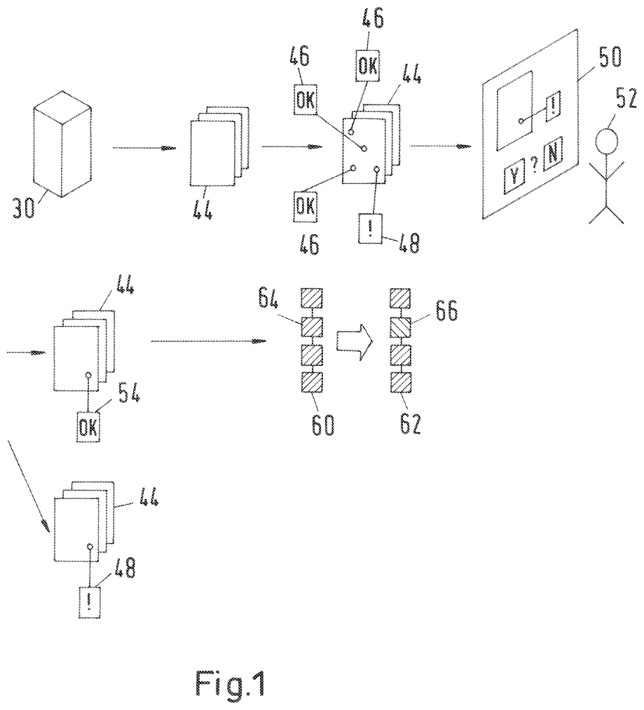

FIG. 1 shows a schematic illustration of the computer-implemented method for analyzing measurement data from a measurement of an object,

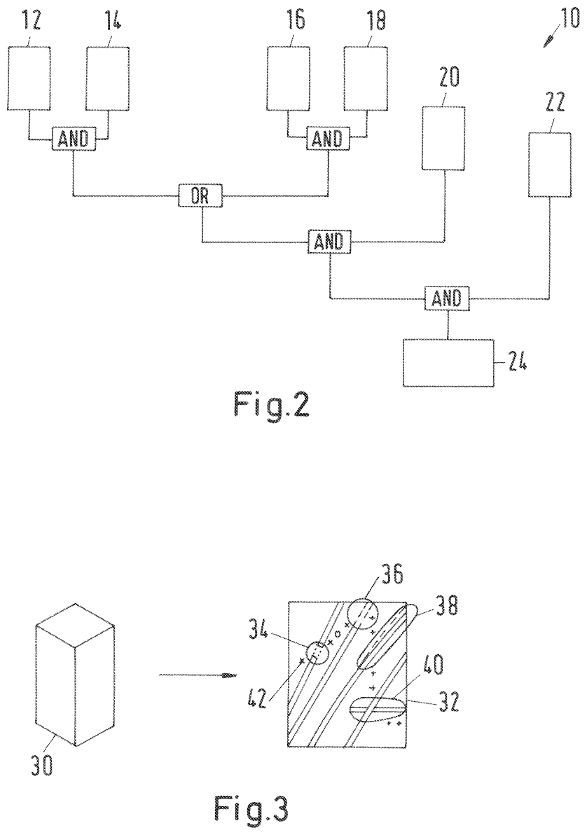

FIG. 2 shows a schematic illustration of an algorithm according to the prior art,

FIG. 3 shows a schematic illustration of deviations in measurement data of an object,

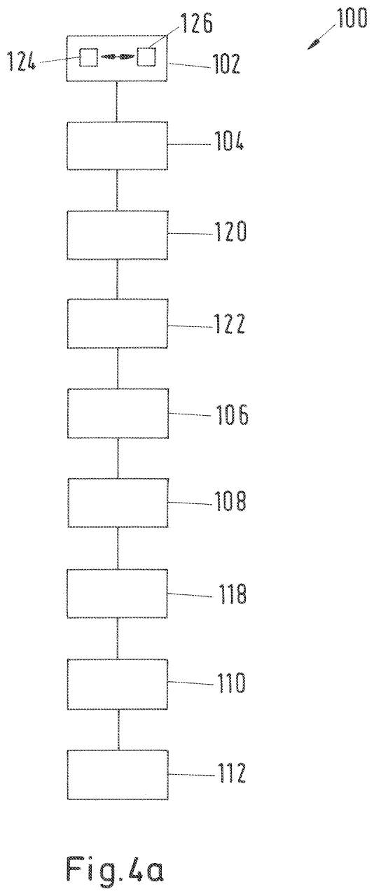

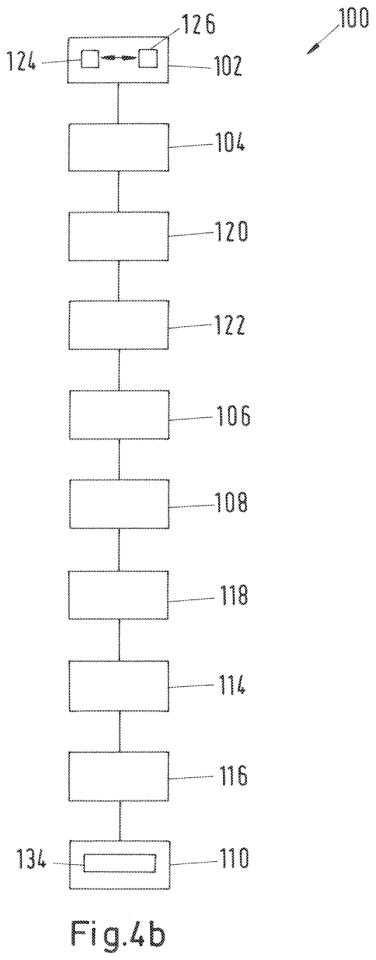

FIGS. 4a, b show flow diagrams of different exemplary embodiments of the method,

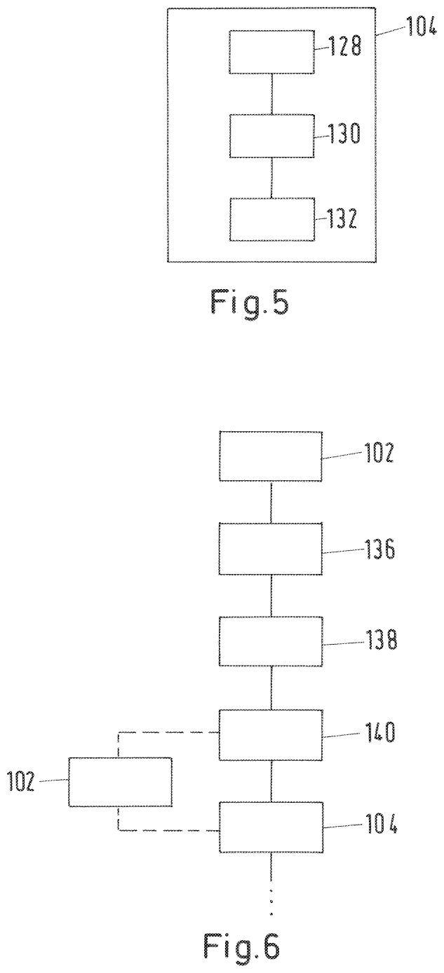

FIG. 5 shows a flow diagram of one exemplary embodiment of a method step, and

FIG. 6 shows a partial flow diagram of a further exemplary embodiment of the method.

FIG. 1 illustrates one embodiment of the computer-implemented method according to the invention. The sequence of the method will be explained in greater detail on the basis of the example of the measurement of one object 30. However, the method is used for measuring and analyzing a plurality of objects.

In the present example, the object 30 is measured automatically by means of an imaging method. However, the measurement can also be effected in a different way, e.g. manually. Measurement data 44 of the object 30 result from the imaging method. An analysis data set assigned to the object 30 is created from the measurement data 44 in an automated manner by means of an algorithm. The analysis data set comprises analysis results 46, 48 about the conformity of the assigned object 30 to the target state of the object 30. That is to say that the analysis results 46, 48 assess whether the corresponding measurement values evaluated in the respective analyses lie within or outside predefined tolerance ranges.

The analysis results 46 indicate here that the corresponding analyses at specific positions in the object 30 are okay or “OK”, that is to say that they lie within the predefined tolerance ranges. The analysis result 48 is illustrated with an “!”, indicating that the analysis result 48 must be checked. In this case, it is possible to stipulate that analysis results are checked if they indicate a result outside the predefined tolerance ranges, that is to say that an analysis at a specific position in the object 30 reveals that the object 30 is not okay at this position. Alternatively or additionally, it is possible to stipulate that analysis results are checked if they are identified as an uncertain analysis result, that is to say that the algorithm cannot ascertain, or cannot ascertain with required certainty, whether the analysis result is assessed as “okay” or “not okay”.

Those analysis data sets which have analysis results 48 which must be checked are submitted to a user 52 via a user interface 50. In this case, the user interface 50 can be a monitor of a computer or a touchscreen, for example, but is not restricted to these exemplary embodiments.

The user 52 checks whether the analysis result 48 is correct. If the user is satisfied with the analysis result 48, the latter is not modified. Furthermore, the user 52 has the option of modifying the analysis result 48 to an adapted analysis result 54 if the user concludes that the analysis result 48 is not correct.

The adapted analysis data set having the adapted analysis result 54 is communicated to the adaptive algorithm. In this case, the adaptive algorithm modifies its state from an initial state 60 to a modification state 62. In this case, the transition from the initial state 60 to the modification state 62 can be effected for example by the modification of a step 64 of the initial state 60 of the algorithm to a step 66 of the modification state 62. In the modification state 62, the adaptive algorithm is improved by comparison with the initial state 60 and, in future analyses having a similar measurement task to that underlying the adapted analysis data set, will yield with higher probability an analysis result 54 that does not have to be checked by a user.

Determining analysis data sets before the checking by the user 52 can be carried out by means of a conventional algorithm according to the prior art. Such a conventional algorithm uses predefined decision criteria as a basis for assessing whether or not an object is okay. One example of a decision tree underlying the decisions of a conventional algorithm is illustrated in FIG. 2.

In accordance with FIG. 2, the decision tree has several conditions 12 to 22, which are logically combined with one another either by “AND” logic operations or “OR” logic operations. In this regard, for example, the condition 12 may demand a wall thickness within a predefined tolerance. Furthermore, the condition 14 may demand for example a pore size in the material of the object which are less than 0.3 mm. The conditions 12 and 14 must be met simultaneously in this case. Alternatively, the conditions 16 and 18 must be met simultaneously, wherein the conditions 16 demands that the wall thickness is out of tolerance by a maximum of 0.1 mm, and condition 18 stipulates that no pores be present in the material.

Condition 20 must additionally be met, which demands a deviation of less than 0.1 mm with respect to a CAD model. Furthermore, condition 22 stipulates that all further measurement results must be within the tolerances.

On the basis of this decision tree, the result 24 indicates that the object 30 is either okay or not okay. However, the functionality of the object cannot necessarily be deduced in this way since the decision tree cannot ideally simulate the complex relationships that influence the functionality. In order to avoid unnecessary rejects of actually functional objects 30, in the case of deviations from the target state of the object, if result 24 indicates for example that the object 30 is not okay, checking by the user should therefore be carried out. Furthermore, the decision tree can also be set up such that the result 24 indicates that the decision cannot be taken clearly and must necessarily be checked by the user. These decisions can be analyzed, inter alia, in each case for the object 30 as a whole, but also for individual defects or regions in or on the object 30.

One example of deviations from a target state of an object is defects in composite fiber materials, which are illustrated in FIG. 3. A slice image 32 from the volume of the object 30 is illustrated here, which may have been determined for example on the basis of a measurement by computed tomography. In this regard, a fiber fracture is illustrated in the region 34, the fiber having been separated in this region. A missing piece of a fiber is illustrated in region 36. The region in which a fiber was previously present is now an empty space in the matrix material in which the fibers are embedded. The empty spaces may be air inclusions. The connection between the fiber and the matrix material has been lost in the region 38, and so a vacancy has likewise formed in the matrix material. The region 40 shows fractures in the structure of the matrix material.

The regions 34, 36, 38, 40 are connected by a fracture 42 that occurred subsequently and extends transversely through the slice image 32. The fracture 42 may be a consequence of the defects in the regions 34, 36, 38, 40. Taken by themselves, each of the defects in the regions 34, 36, 38, 40 could not impair the usability of the object 30. In their sum, however, in this example the fracture 42 results in a lack of functionality of the object 30. Representing the lack of functionality of the object 30 owing to the possible occurrence of a fracture with a predefined decision tree with a conventional algorithm can result in incorrect decisions in the event of slight deviations of the defects in the analyzed regions.

In this case, an alternative or additional example can involve just analyzing whether vacancies or air inclusions in the material adversely influence the functionality of the object 30. This simplifies and accelerates the analysis. In this case, the material of the object 30 need not necessarily comprise a composite fiber material, but rather can be e.g. a plastic, a metal or a ceramic, etc., which has air inclusions.

The computer-implemented method 100 according to the invention, which supplies an adaptive algorithm with realistic analysis data sets adapted by a user for the purpose of improving the adaptive algorithm, is illustrated in FIGS. 4a and 4b, which show different embodiments of the method 100 by way of example.

In accordance with FIG. 4a, the method 100 comprises, in a first step 102, determining measurement data of a plurality of objects. In this case, the determination of the measurement data can be based on measurement tasks of identical type. In this case, a large number of objects are measured successively or simultaneously by means of identical or similar analyses and/or identical or similar analysis targets. The determination of measurement data here can also mean that measurements that have already been carried out are loaded from a memory. In this case, measurement tasks on the basis of the example of composite materials can comprise for example searching for vacancies in the matrix material which were produced by fractures, fiber losses or fiber detachments from matrix material. In the case of molded/cast objects or objects produced by additive manufacturing methods, the measurement task can comprise for example finding voids or foreign material inclusions. However, the measurement tasks can vary even further and be individually coordinated with an object or a method for producing the object.

The measurement data can be volume data, for example, which were determined by means of a measurement by computed tomography. In this case, the measurement by computed tomography is effected during step 102 in a step 124 after the production of the object.

Alternatively or additionally, in the case of a method for additive manufacturing of the object for step 102 in a step 126 the process data determined during the manufacturing can be provided as volume data. In this case, the process data are present directly in spatially resolved fashion and are thus already available during the production of the object. Thus, analyses for the already completed parts of the object can already be carried out during the production of the object.

In further examples (not illustrated) of determining volume data, it is also possible to use measurement data from ultrasound methods, magnetic resonance tomography and further imaging methods.

Furthermore, the possible analyses are not restricted to volume data, however. In this regard, deviations from the conformity of the object to the target state can also be determined by two-dimensional radiographs provided by means of radiographic methods, for example, or by an optical inspection of objects by means of camera images.

In a step 104, analysis data sets are determined from the measurement data for the objects. In this case, an analysis data set is assigned to one of the objects. Furthermore, each analysis data set has at least one analysis result about the conformity of the assigned object to the target state of the object. Determining the analysis data sets is effected automatically by means of a computer-implemented algorithm. In this case, in a first exemplary embodiment, the computer-implemented algorithm can be the adaptive algorithm that is trained and improved in the further steps. In a further exemplary embodiment, determining the analysis data sets can be carried out by a conventional algorithm in accordance with the prior art.

In accordance with FIG. 5, step 128 can be provided in step 104; step 128 involves assessing deviations from the target state in the interior of the object. These deviations may be defects, for example. In this case, the measurement data also show the interior of an object and not just the surfaces thereof.

Optionally, furthermore, in accordance with FIG. 5, during step 104, in a further step 130 provision can be made for determining segmentation data on the basis of the measurement data. In this case, the segmentation data describe an internal spatial composition of the object. Furthermore, assessing the deviations in the interior of the object is carried out on the basis of the segmentation data by means of the adaptive algorithm. The deviations can be brought to a geometric shape on the basis of the segmentation data. That is to say that the geometric shape of the region in which the deviation is arranged can be determined.

Furthermore, in accordance with FIG. 5, step 132 can optionally be provided in step 104. Step 132 involves determining a local wall thickness at a position of the deviation. Assessing deviations in the interior of the object is carried out on the basis of the local wall thickness determined. In this case, the assessing can be effected with regard to the functionality of the object.

FIG. 4a furthermore illustrates step 120, in which an analysis data set is marked if the analysis data set has at least one analysis result about the conformity of the assigned object to the target state which is not unambiguous. In a further step 122, only the marked analysis data sets are used in order to submit them to the user for checking in a step 106. In this case, the analysis data sets can be marked by means of known data processing techniques. As a result of the marking of the analysis data sets to be checked, in each case only uncertain or ambiguous analysis results are submitted to the user for checking. Certain analysis results thus need not be checked by the user. Steps 120 and 122 are optional, however.

Furthermore, in step 106, the analysis results of at least some of the analysis data sets are checked by the user. The user is given the opportunity to check the automatically determined analysis results. In this case, the user can view the measurement data and evaluate the analysis results accordingly. Depending on the embodiment, only the marked analysis data sets or else further analysis data sets such as, for example, all analysis data sets having analysis results that turn out to be negative, i.e. including the unambiguous analysis results, are submitted to the user.

In accordance with step 108, the user can adapt an analysis result in an analysis data set on the basis of the measurement data if the user does not agree with the analysis result, i.e. if the user determines an analysis result about the conformity of the assigned object to the target state which deviates from the original analysis result. This then results in an adapted analysis data set.

In accordance with step 118, the adapted analysis data sets can be provided by way of an output unit, and thus be output directly as the final result of the analysis. The adapted analysis data sets are thus used as the final result of the quality assurance.

In this case, in step 110, the adapted analysis data sets are communicated to the adaptive algorithm. The adaptive algorithm modifies itself on the basis of the adapted analysis data sets. That is to say that the adaptive algorithm improves itself on the basis of the adapted analysis data sets. The improved adaptive algorithm can determine analysis data sets from further measurement data of objects which require fewer checks by a user in comparison with before the improvement.

If the adaptive algorithm was used for determining the analysis data sets from the measurement data for the objects in step 104, a direct improvement of the analysis results of the adaptive algorithm is effected by the combination of steps 106 to 110.

If, in an alternative exemplary embodiment, a conventional algorithm determines the analysis data sets from the measurement data for the objects in step 104, the adaptive algorithm improves itself in comparison with the conventional algorithm through step 110. In this case, the conventional algorithm can be an assessment algorithm. In accordance with step 112, the conventional algorithm is replaced by the adaptive algorithm if a predefined minimum number of adapted analysis data sets have been communicated to the adaptive algorithm and/or after a predefined minimum number of analysis data sets have been determined by the conventional algorithm.

A further alternative exemplary embodiment of the method 100 is illustrated in FIG. 4b. Instead of step 112 after step 110, steps 114 and 116 can be provided before or after step 110. FIG. 4b here illustrates only the case where steps 114 and 116 are carried out before step 110, but the alternative after step 110 is not excluded. The explanations given above are applicable to the further steps carried out before the two steps 114 and 116.

In step 114, training analysis data sets are determined by the adaptive algorithm on the basis of the measurement data. This determination of training analysis data sets is the same as the determination of analysis data sets in accordance with step 104. However, the training analysis data sets are not checked by a user, nor are they used for the decision about the functionality of the object.

In step 116, the adapted analysis data sets, i.e. the analysis data sets checked by the user and modified, are compared with the corresponding training analysis data sets respectively assigned to the same object before the adapted analysis data sets are communicated to the adaptive algorithm. The assessment algorithm in step 104 is replaced as soon as the adaptive algorithm determines at least some training analysis data sets which have the same result as the adapted analysis data sets. That is to say that as soon as the adaptive algorithm produces fewer analysis results requiring checking by the user than the conventional algorithm, the conventional algorithm is replaced by the adaptive algorithm in accordance with step 116.

Optionally, in all of the exemplary embodiments, step 110 can furthermore comprise step 134, wherein simulated analysis data sets are communicated to the adaptive algorithm. In this case, the adaptive algorithm modifies itself on the basis of the simulated analysis data sets. In this case, the simulated analysis data sets are based on simulated measurement data resulting from a realistic simulation.

FIG. 6 describes a further exemplary embodiment, in which steps 136, 138 and 140 are carried out between steps 102 and 104.

In accordance with step 136, after determining the measurement data, provisional analysis data sets are determined from the measurement data for the objects by means of a defect recognition algorithm. The defect recognition algorithm can be a conventional algorithm. A provisional analysis data set is assigned to one of the objects and has at least one analysis result about the conformity of the assigned object to the target state.

In step 138, the provisional analysis result is checked by the defect recognition algorithm in respect of whether it has a deviation of the conformity of the assigned object to the target state within a predefined range. In this case, the predefined range can be assigned to analysis results which do not allow a clear assessment about the functionality of the measured assigned object.

Provisional analysis results which are not assigned to the predefined range are output as final analysis results of the quality control. If a provisional analysis result is assigned to the predefined range, in accordance with step 140 the measurement data underlying the analysis result are communicated to the adaptive algorithm, which repeats step 102 instead of the defect recognition algorithm. The analysis data set resulting from the adaptive algorithm is then output as the result of the quality control if checking by the user is not necessary.

Furthermore, in any embodiment the computer-implemented method 100 described above can be performed by a computer which, under the control of a computer program product, carries out instructions that cause the computer to carry out the computer-implemented method 100.

The preceding steps can be carried out successively or with at least partial temporal overlap, provided that the respective logical prerequisites for carrying out the steps are given.

The invention is not restricted to any of the embodiments described above, but rather is modifiable in diverse ways.

All features and advantages evident from the claims, the description and the drawing, including structural details, spatial arrangements and method steps, may be essential to the invention both by themselves and in a wide variety of combinations.

### LIST OF REFERENCE SIGNS

30 Object
32 Slice image
34 Region
36 Region
38 Region
40 Region
42 Fracture
44 Measurement data
46 Analysis result
48 Analysis result
50 User interface
52 User
54 Adapted analysis result
60 Initial state
62 Modification state
64 Step of an algorithm
66 Modified step of an algorithm

1. A computer-implemented method for analyzing measurement data from a measurement of an object, wherein the analysis assesses whether the object corresponds to a target state, wherein the method comprises the following steps:
determining measurement data of a plurality of objects;
determining analysis data sets from the measurement data for the objects, wherein an analysis data set is assigned to one of the objects and has at least one analysis result about the conformity of the assigned object to the target state;
checking, by a user, the analysis results of at least some of the analysis data sets;
adapting an analysis result of a checked analysis data set if the checking by the user yields a deviating analysis result about the conformity of the assigned object to the target state; and
communicating at least the adapted analysis data sets to an adaptive algorithm, wherein the adaptive algorithm modifies itself on the basis of the adapted analysis data sets in order to determine analysis data sets from further measurement data of objects by means of the modified adaptive algorithm;
wherein the steps are carried out successively or with at least partial temporal overlap.

2. The computer-implemented method as claimed in claim 1, characterized in that determining analysis data sets from the measurement data for the objects is performed by means of an assessment algorithm, which is different than the adaptive algorithm, and the method additionally comprises the following step:
replacing the assessment algorithm by the adaptive algorithm after a predefined minimum number of adapted analysis data sets have been communicated to the adaptive algorithm and/or after a predefined minimum number of analysis data sets have been determined.

3. The computer-implemented method as claimed in claim 1, characterized in that determining analysis data sets from the measurement data for the objects is performed by means of an assessment algorithm, which is different than the adaptive algorithm, and after the checking of the analysis data sets by the user the method comprises the following step:
determining training analysis data sets from the measurement data for the objects by means of the adaptive algorithm; and
comparing the adapted analysis data sets with the corresponding training analysis data sets before communicating the adapted analysis data sets to the adaptive algorithm;
wherein the assessment algorithm is replaced by the adaptive algorithm if at least some of the adapted analysis data sets match the corresponding training analysis data sets.

4. The computer-implemented method as claimed in claim 3, characterized in that the method additionally comprises the following step:
providing the adapted analysis data sets for the assigned objects by way of an output unit.

5. The computer-implemented method as claimed in claim 4, characterized in that before the checking of the analysis data sets by a user the method comprises the following step:
marking an analysis data set if at least one analysis result about the conformity of the assigned object to the target state is not unambiguous; and
using only the marked analysis data sets during the checking of the analysis data sets by the user.

6. The computer-implemented method as claimed in claim 5, characterized in that the measurement data provide at least one partial representation of a volume arranged within an object.

7. The computer-implemented method as claimed in claim 6, characterized in that determining measurement data of a plurality of objects comprises the following step:
providing volume data as measurement data by means of a measurement by computed tomography.

8. The computer-implemented method as claimed in claim 6, characterized in that determining measurement data of a plurality of objects comprises the following step:
providing volume data as measurement data by means of process data of a measurement during additive manufacturing of an object.

9. The computer-implemented method as claimed in claim 8, characterized in that determining analysis data sets from the measurement data for the objects comprises the following step:
assessing deviations from the target state in the interior of the object.

10. The computer-implemented method as claimed in claim 9, characterized in that the deviations are air inclusions.

11. The computer-implemented method as claimed in claim 9, characterized in that determining analysis data sets from the measurement data for the objects, before assessing deviations in the interior of the object, comprises the following step:
ascertaining segmentation data on the basis of the measurement data, wherein the segmentation data describe an internal composition of the object;
wherein assessing deviations in the interior of the object is carried out on the basis of the segmentation data by means of the adaptive algorithm.

12. The computer-implemented method as claimed in claim 9, characterized in that determining analysis data sets from the measurement data for the objects, before assessing deviations in the interior of the object, comprises the following step:
determining a local wall thickness at a position of a deviation;
wherein assessing deviations in the interior of the object is carried out on the basis of the local wall thickness.

13. The computer-implemented method as claimed in claim 12, characterized in that communicating at least the adapted analysis data sets to the adaptive algorithm, wherein the adaptive algorithm modifies itself on the basis of the adapted analysis data sets, comprises the following step:
communicating (134) simulated analysis data sets based on simulated measurement data to the adaptive algorithm, wherein the adaptive algorithm modifies itself on the basis of the simulated analysis data sets.

14. The computer-implemented method as claimed in claim 13, characterized in that before determining analysis data sets from the measurement data for the objects the method comprises the following steps:
determining provisional analysis data sets from the measurement data for the objects by means of a defect recognition algorithm, wherein a provisional analysis data set is assigned to one of the objects and has at least one analysis result about the conformity of the assigned object to the target state;
determining, by means of the defect recognition algorithm, whether the analysis result has a deviation of the conformity of the assigned object to the target state within a predefined range; and
communicating the measurement data of the objects whose provisional analysis data sets have an analysis result having a deviation of the conformity of the assigned object to the target state within the predefined range to the adaptive algorithm for determining analysis data sets from the measurement data for the objects.

15. A computer program product comprising instructions which are executable on a computer and, when executed on a computer, cause the computer to carry out the method as claimed in claim 1.
